(19) United States
(12) Patent Application Publication
(10) Pub. No.: US 2003/0212779 A1
(43) Pub. Date: Nov. 13, 2003

(54) System and Method for Network Security Scanning

(76) Inventors: Brian A. Boyter, San Antonio, TX (US); R. Gunnar Engelbach, San Antonio, TX (US); Randal S. Taylor, San Antonio, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/249,666

(22) Filed: Apr. 29, 2003

Related U.S. Application Data
(60) Provisional application No. 60/376,489, filed on Apr. 30, 2002.

(51) Int. Cl. G06F 15/173

(52) U.S. Cl. 709/223

(57) ABSTRACT

A network appliance for scanning network nodes to determine open ports and vulnerabilities to attack by unauthorized users. A user initializes the system and method by remotely configuring the network scanner, initiating a new job by defining IP address ranges to be scanned, and iteratively assessing the vulnerabilities of assigned active network nodes. The vulnerability assessment comprises scanning all host network nodes within a user specified range of IP addresses, scanning all ports of host network nodes found to be active to determine open ports, and scanning all ports to assess vulnerabilities to unauthorized access using vulnerability scanner plug-ins. The vulnerability plug-in modules may be downloaded into a scanner on an “as required” basis. A user may access and configure the network scanner and define ranges of IP addresses to be protected from a remote client workstation.

### CROSS REFERENCE TO RELATED APPLICATIONS

This application claims benefit of U.S. Provisional Application No. 60/376,489, filed on Apr. 30, 2002.

### BACKGROUND OF INVENTION

The invention relates generally to network security, and more specifically to network vulnerability scanners that scan designated nodes in a network to detect potential and actual breaches of security of the designated network nodes such as open ports and vulnerabilities as well as changes in the status of open ports and vulnerabilities.

The need for providing and accessing information throughout small and large enterprise organizations spawned rapid a growth in intranets and extranets to satisfy these organizational communications requirements. With the rapid growth of the Internet as a public network communication medium, organizations found substantial cost savings by using the Internet as an worldwide vehicle for providing and accessing organizational information. The result was a shift from closed and protected to open and less secure, open information infrastructure. Gateways were provided to connect existing private networks to the Internet to replace many private dedicated networks providing access to disparate parts of the world. It is not unusual in today's business environment to have multiple computer workstations and servers interconnected by complex and widely dispersed communications networks. These communications networks are critical to many businesses that rely on these information networks to provide services for the day-to-day operation of their enterprises.

With the growth of these communications networks came an increase in incidences of unauthorized access to these networks by individuals and software programs for accessing confidential information and causing disruptions or irreparable harm to these informational networks. These intrusions, oftentimes resulting in economic losses, have created a demand for means for detecting and preventing malicious and unauthorized access to these networks by users and organizations that seek to find and exploit the smallest security hole. In addition to enterprises instituting safeguards to prevent harm caused to business enterprises and individuals, the government has instituted regulations to protect the privacy of information on individuals that may be available on these information networks.

The Gramm-Leach-Bliley Act requires financial institutions and financial services companies to comply with stringent privacy and security standards. The health care market has similar legislation called the Health Insurance Portability and Accountability Act (HIPAA). While the details of HIPAA are still being completed, it will clearly establish uniform information security standards for health care organizations. Since the late 1980s, the government agencies have been under legislative pressure to secure networked systems. Emerging homeland defense initiatives will add additional and enforceable network security requirements to the government agencies.

In response to unauthorized intrusions into informational networks, various protective measures have been implemented to eliminate or reduce intrusion incidences. Some of these measures include Public Key Infrastructure (PKI) encryption, S/MIME Email security, Secure Sockets Layer (SSL) 128 bit encryption, Virtual Private Network (VPN), firewalls, and vulnerability scanners. Some of these network protection schemes my work at cross-purposes to one another by inhibiting other protection schemes from operating effectively. For example, a firewall may inhibit a vulnerability scanner form assessing the intrusion vulnerability of a system protected by the firewall.

The end user of vulnerability scanners needs to know where system vulnerabilities exist and how to eliminate the vulnerability. These questions must be answered on an almost continuous basis, rather than on a discrete scan cycles that are run at scheduled times. To be effective, many vulnerability scanners must run scans in rapid succession to decrease any window of system exposure to unauthorized access. This approach, however, generates an unwieldy amount of unnecessary data as well as creating bottlenecks in correlating and assessing the results of the collected data. Many “continuous scanners” merely limit scanning to the level of host detection in order to achieve almost continuous scanning operation. Another problem with many vulnerability scanners is that they may be updated to protect against newly discovered threats only on a weekly or monthly schedule.

### SUMMARY OF INVENTION

The present invention may be used as a vulnerability-scanning building block to an enterprise-level security system or alone as a self-contained scanner and reporting system. A secure communications architecture can be used to connect several of these individual systems together for comparison and correlation purposes. An embodiment of the present invention provides vulnerability scanning on a continuous basis to decrease any window of exposure to an attack, while reducing data storage and correlation difficulties by recording only data changes or differentials over time. If there are no changes detected in a target network over several days of continuous scanning, no additional data needs to be stored or correlated. The present invention checks all designated hosts for changes in open ports and vulnerabilities, and receives new or updated plug-in threat modules on at least a daily basis. When a new or updated plug-in threat module is received, it is integrated and executed on a high priority basis to detect any recently discovered security intrusion profiles. The system can be used to notify administrators when new security holes are identified.

An embodiment of the present invention is capable of performing an on-going evaluation of a network's security posture. As new hosts are introduced in the target host range, that new host is automatically evaluated for vulnerabilities. When an existing host makes new services available, the new services are automatically evaluated to determine if they have introduced new vulnerabilities to the network. Even as new vulnerability tests are added to the system, existing hosts and ports are automatically re-checked to see if a new threat has been introduced in the absence of re-configurations. The present invention turns into a fulltime watch guard for critical systems and servers, giving the administrator insight on how a system's security posture changes overtime, even if a user or hacker opens only short windows of exposure.

The system is fully capable of tracking and managing security issues for a set of hosts. The on-board database facilitates status tracking, full reporting, and even task management. When run in server mode (that is, with no keyboard, video, or mouse), database connections are permitted from secondary access points such as workstations, laptops, and handheld PCs. This database, therefore, will have internal security measures taken to ensure all non-scanner accesses are physically limited to an authorized level of operation.

The system is written in Java programming language that is portable and platform independent. For example, the present network invention may be implemented on various application platforms, including those running Linux, Sun Solaris, Microsoft Windows or Apache operating systems. Although some functionality may be limited by a host operating system's ability to facilitate the usage of a few low-level functions such as raw sockets, most modules of the system will work regardless of the host operating system. The present invention may be operated in either a client or server configuration.

An embodiment of the present invention is a method for scanning network nodes for detection and reporting of security vulnerabilities, comprising the steps of scanning all network host nodes within designated address ranges for determining all active hosts, scanning all ports in each active host for determining all open ports, scanning each port of each active host for detecting security vulnerabilities, notifying a user of all open ports and detected security vulnerabilities, and repeating the scanning and notifying steps above in an iterative manner. The method may further comprise the steps of initiating a new scan job by entering a new set of address ranges by a user into a control database, and executing an initial high priority port scan based on detecting an active host having an address within the new set of address ranges. The step of scanning all network nodes within designated address ranges may further comprise the steps of accessing a control database for determining designated address ranges, storing the status of each active host and inactive host in the control database, and removing a host designated as inactive from the control database if the host remains inactive for a predetermined number of scan cycles. The step of removing a host designated as active may comprise removing a host designated as inactive from the control database if the host remains inactive for a predetermined time period. The method may further comprise the steps of adding a new host designated as active to the control database when first detected, and executing an initial high priority port scan based on detecting a new active host. The step of scanning all ports may comprise the steps of simultaneously scanning each port using a User Datagram Protocol bind attempt and a Transmission Control Protocol connection attempt, determining the state of the User Datagram Protocol bind upon completion of the Transmission Control Protocol connection attempt, confirming a closed state of a port upon failure of either the User Datagram Protocol bind attempt or the Transmission Control Protocol connection attempt, confirming an open state of a port if both the User Datagram Protocol bind remains valid and the Transmission Control Protocol connection attempt was successful, and determining a rate limiting of the target host and the round trip time of the network connection to that host. The method may further comprise the step of tracking, port status changes over time for reporting the changes to a user. The step of scanning all ports may comprise the steps of accessing a control database for determining a designated highest priority active host, scanning all ports on the designated active host for determining open ports, storing the status of each open port and each closed port in the control database, and removing a port designated as closed from the control database if the port remains closed for a predetermined number of scan cycles. The step of removing a port designated as closed may comprise removing a port designated as closed from the control database if the port remains closed for a predetermined time period. The method may further comprise the step of adding a new port designated as open to the control database when first detected. The step of scanning each port of each node may comprise the steps of accessing a control database for determining a designated highest priority group of active hosts, for each host in the group of-designated active hosts, checking the dependency criteria for each vulnerability plug-in module in a plug-ins database, running a vulnerability plug-in module against each host and port combination that meets the dependency criteria of each plug-in module, storing the status of each vulnerability found in the control database, removing a vulnerability designated as closed from the control database if the vulnerability remains closed for a predetermined number of scan cycles, and reducing the number of vulnerability tests using the current knowledge of the target host and service. The step of removing a vulnerability designated as closed may comprise removing a vulnerability designated as closed from the control database if the vulnerability remains closed for a predetermined time period. The method may further comprise the step of adding a new vulnerability designated as open to the control database when first detected. The method may further comprise the step of tracking vulnerability status changes over time for reporting the changes to a user. The method may further comprise the steps of periodically checking a central application server for new versions of plug-in modules, retrieving plug-in modules from the central application server that have later versions than the corresponding plug-in modules stored in the plug-ins database, storing the latest updated version plug-in modules in the plug-ins database, reading the dependency criteria of each updated plug-in module and generating a priority list of hosts that match the criteria, setting a highest priority for vulnerability scanning to the hosts on the priority list, and performing a vulnerability assessment on each host on the priority list by scanning the hosts. The step of notifying a user may comprise transmitting all host, port, and vulnerability status to a graphical user interface on a client workstation via a user interface gateway and a communications network. The step of notifying a user may comprise a snapshot having a periodicity determined by the user. A computer-readable medium may contain instructions for controlling a computer system to implement the method described above.

Another embodiment of the present invention is a system for scanning network nodes for detection and reporting of security vulnerabilities, comprising means for scanning all network host nodes within designated address ranges for determining all active hosts, means for scanning all ports in each active host for determining all open ports, means for scanning each port of each active host for detecting security vulnerabilities, and means for notifying a user of all open ports and detected security vulnerabilities. The system may further comprise a graphical user interface connected to a control database via a user interface gateway and a communications network for initiating a new scan job by entering a new set of address ranges by a user into a control database, and a daemon supervisor and a high priority port scanner daemon for executing an initial high priority port scan based on detecting an active host having an address within the new set of address ranges. The means for scanning all network nodes within designated address ranges may comprise a host scanner daemon for accessing a control database, for storing the status of each active host and inactive host in the control database, for removing a host designated as inactive from the control database, and adding a new host designated as active to the control database when first detected. The system may further comprise a high priority port scanner daemon for executing an initial high priority port scan based on detecting a new active host. The means for scanning all ports may comprise a port scanner daemon for determining the open or closed status of each port of each host node. The means for scanning all ports may comprise a port scanner daemon for accessing a control database, scanning all ports on a designated active host, storing the status of each open port and each closed port in the control database, and removing a port designated as closed from the control database. The means for scanning each port of each active host may comprise a vulnerability scanner daemon for accessing a control database, checking the dependency criteria for each vulnerability plug-in module in a plug-ins database, running a vulnerability plug-in module against each host and port combination that meets the dependency criteria of each plug-in module, storing the status of each vulnerability found in the control database, and removing a vulnerability designated as closed from the control database. The system may further comprise a plug-in delivery facility for periodically updating plug-in modules in a plug-ins database used for detecting vulnerabilities. The means for notifying a user may comprise a graphical user interface on a client workstation connected to a control database via a communications network and a user interface gateway for receiving all host, port, and vulnerability status. The system may further comprise means for collecting snapshots of current system status as determined by the user.

Yet another embodiment of the present invention is a system for scanning network nodes for detection and reporting of security vulnerabilities, comprising a user interface on a client workstation connected to a network scanner via a communications network and a user interface gateway for configuring and initializing the scanner, defining scan jobs, and receiving results of security assessments of designated host nodes within a network, and the network scanner system including a daemon supervisor, a host scanner daemon, an operating system daemon, a port scanner daemon, a vulnerability scanner daemon, a control database, and a plug-in database.

### BRIEF DESCRIPTION OF DRAWINGS

These and other features, aspects and advantages of the present invention will become better understood with regard to the following description, appended claims, and accompanying drawings wherein:

FIG. 1 shows a functional block diagram according to an embodiment of the present invention;

FIG. 2 shows a flow diagram of the operation of an embodiment of the present invention;

FIG. 3 shows screen shots used for adding jobs to a scanner using the Graphical User Interface;

FIG. 4 shows an embodiment of a Risk Manager for reviewing scan results; and

FIG. 5 shows a screenshot used by a user to save the state of a scan as a snapshot.

### DETAILED DESCRIPTION

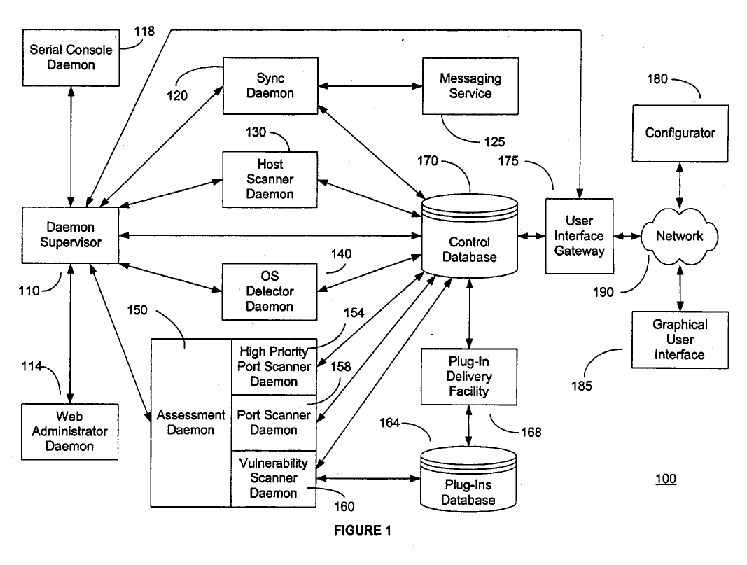

Turning now to FIG. 1, FIG. 1 shows a functional block diagram 100 according to an embodiment of the present invention. The modules shown in FIG. 1 are separated by functionality and each one coordinates with the others through a single Control Database 170. All system modules are started and monitored by a Daemon Supervisor module 110. The Daemon Supervisor 110 re-instantiates a module if the particular module fails for any reason. Most system interactions occur via the Control Database 170. Configuration settings and the definitions of desired work tasks are entered via the Configurator 180 and communicated into the Control Database 170 via the User Interface Gateway 175. The first step of the process is to define a scan range using a Configurator 180 via a Network 190 through the User Interface Gateway 175. Once the range is defined and marked as active, a Host Scanner or Discovery module 130 performs a discovery scan against all potential hosts within that defined range. Identified hosts get added to the Control Database 170 with no associated ports. This discovery is performed on an on-going basis, continually adding new hosts to the Control Database 170 as they are found. Since discovery locates hosts very rapidly and with almost negligible bandwidth utilization, it is performed on a frequent basis, allowing for a more rapid detection of new or removed hosts.

As soon as a host gets added to the database, the High Priority Port Scanner Daemon 154 begins a quick scan of those ports with the highest likelihood of having vulnerabilities on them. This is followed by an initial vulnerability evaluation on any of these ports that are found to be open. This technique allows the system to locate the majority of the most critical vulnerabilities rapidly. Both the High Priority Port Scanning and the Full Port Scanning are preceded by an assessment of the network and target conditions whereby the daemons perform a series of tests to determine the ideal delay to allow for the test packet round trip time and any rate limiting that might be employed by the target host. This extra step determines the fastest possible time under which the target host can be scanned accurately given current network conditions. After the initial high-priority evaluation, the Port Scanner Daemon 157 begins its work of finding all open ports on each target by assessing all 65,535 available ports. This operation is accomplished by using a User Datagram Protocol (UDP)-bind-wrapped Transmission Control Protocol (TCP)-connection. Using this technique, the associated UDP and TCP ports are scanned simultaneously in a manner, which assesses both protocols in about the same time it takes to do just the TCP protocol. This audit of open ports is performed on an on-going basis, continually making updates to the Control Database 170 as changes occur. These changes are tracked over time in the database allowing the end user to observe configuration changes over time via the Graphical User Interface 185. The Port Scanner Daemon 158 performs this full scan in blocks of 1024 ports at a time, a technique that allows a Vulnerability Scanner Daemon 160 an opportunity to perform its assessments without having to wait for the complete port scan, which is the most time-consuming part of a full evaluation. By dynamically balancing the workload between the High Priority Port Scanner Daemon 154, Port Scanner Daemon 158, and Vulnerability Scanner Daemon 160, the system makes maximum use of its resources without flooding the host network. Note that the High Priority Port Scanner Daemon 154, the Port Scanner Daemon 158 and the Vulnerability Scanner Daemon 160 are part of and run under control of an Assessment Daemon 150.

By matching data points found by the Host Scanner Daemon 130 and Port Scanner Daemon 158, the Vulnerability Scanner Daemon 160 selects plug-ins from the Plug-ins Database 164 and runs them against the appropriate host:port. Results are stored in the Control Database 170 as they are found. This evaluation is performed in an on-going basis, continually making database updates as changes occur. These changes are tracked in the Control Database 170, allowing the end-user to observe changes in the hosts' security posture over time.

An embodiment of the present invention uses a priority mechanism to determine scan order of targets. As certain attributes of a host grow to be out of date relative to other hosts, they raise in priority. The scanning engine processes sub-jobs by priority giving all targets a chance to be evaluated. When a new host, or a new port on an existing host is found it is placed at the top of the priority list to be scanned immediately using the High Priority Port Scanner Daemon 154. An administrator has the ability to give specific hosts a higher priority than others, and therefore a more frequent re-evaluation, augmenting this priority mechanism.

The system provides the user an opportunity to access the data with a JDBC-compliant application. Security measures are taken within the database to keep access limited to authorized personnel, and to keep authorized personnel from accessing data they are not permitted to see. The user application Graphical User Interface 185 provides all data manipulation, data review, and job control that the end-user requires to make full use of the capabilities of the system. This includes a fully functional reporting engine as well as a risk management system that helps an administrator to track and manage security configuration updates that need to be applied to each host. Furthermore, the Graphical User Interface 185 can be configured to display alerts when new hosts or vulnerabilities are identified. Even if a vulnerability is introduced and removed between viewing sessions, a user can review any alerts that were triggered on his next login.

Considering the Daemon Supervisor 110, the purpose of the Daemon Supervisor 110 is to start all scanner daemons at system initiation, and ensure that they are restarted upon failure. The Daemon Supervisor module 110 starts when the system boots, and stays running until the system is shutdown. The Supervisor daemon is responsible for starting up and monitoring all of the major subsystems, including the User Interface Gateway 175, the Web Administrator Daemon 114, the Serial Console Daemon 118, the Host Scanner or Discovery Daemon 130, the Assessment Daemon 150, and the OS Detection Daemon 140. Depending upon the configuration, the Daemon Supervisor module 110 instantiates the scanner daemons that then performs work based on database settings. The Daemon Supervisor module 110 keeps tabs on which daemons are running, and restarts any that fail for any reason. Since this job is so crucial, the Daemon Supervisor 110 receives no other tasking to ensure simplicity and reliability. On system startup, the Supervisor Daemon 110 must reference an externally configurable list of processes stored in the Control Database 170 that need to be started, and starts them. In addition, the Supervisor Daemon 110 must react to watched daemons that terminate by restarting them and logging their need to be restarted. Failure to keep a watched daemon running must generate an alert that is viewable through the Graphical User Interface 185.

Considering the Host Scanner Daemon 130, the purpose of the Host Scanner Daemon 130 is to detect live hosts within a set of specified target ranges, to record their periods of downtime, and to record their removal from the network. Once provided a scan range, the Host Scanner Daemon 130 begins an iterative discovery process looking for any network presence within the specified scan ranges. Once identified, the host is added to the appropriate table in the Control Database 170 along with any information the Host Scanner Daemon 130 was able to extract via the scan. After the initial iteration, this scanner continues to check the availability of hosts that were identified while continuing to look for hosts that are later introduced to the network. When a host is removed, the Host Scanner Daemon 130 marks it as down to alert other daemons and end-users of its inaccessibility. Long periods of downtime result in the Host Scanner Daemon 130 removing the host from the system. Host scanning is performed on a priority-driven model. When a host is first detected by the scanning system, it receives the highest priority and is thus scanned immediately. When the scan is completed, it gets moved to the bottom of the priority list, allowing existing hosts to float towards the top. This approach provides a non-deterministic yet effective way to give all hosts a fair evaluation cycle. The Host Scanner Daemon 130 must continually check all IP addresses in a given list or range to determine availability, and must record all IP addresses that provide a response with a “live-host” indication that other processes can read and react to. The host checking process must not rely upon Internet Control Message Protocol (ICMP) for host detection, and must use a priority-based system to determine when to re-scan a host. Once a host is scanned, it is moved to the bottom of the priority list and filters to the top over time. As new scan lists and ranges are added to the job queue, the new IP addresses are placed at the top of the priority ordering system. The Host Scanner Daemon 130 host-scanning priority system works on a “time-last-checked” basis to keep attributes from having to be updated to increase priority levels. It must be capable of detecting hosts with firewalls that may have one or only a few ports open from the scanner's vantage point.

Considering the Operating System (OS) Detector Daemon 140, the purpose of the OS Detector Daemon 140 is to determine the operating system of a host and to calculate a probability of accuracy in that determination. The OS Detector Daemon 140 reads the results of the Host Scanner Daemon 130 that are stored in the Control Database 170, and performs an analysis for each host. This analysis uses various OS fingerprinting techniques to estimate the operating system used by that host. Unlike other OS detection tools, this estimate includes a probability of accuracy measure. This daemon does not need to do continuous assessments of the hosts, since a one-time process on host detection is sufficient. However, if the probability is below a configurable threshold, a recheck may be warranted after other scanner daemons gather more information about available services on that host. The OS Detector Daemon 140 must take input from the Host Scanner Daemon 130 via the Control Database 170. Once a host has been found, the OS Detector Daemon 140 must perform an initial fingerprinting exercise and make a best estimate determination of the OS type, and must also calculate a certainty percentage that represents a probability of the host being the selected OS type. As additional information becomes available from other scanning daemons (such as information collected by the Port Scanner Daemon 158) the OS Detector Daemon 140 must re-evaluate and update its probability or even change the OS type for that host, if appropriate.

Considering the Assessment Daemon 150, the purpose of the Assessment Daemon 150 is to start further sub processes based on the priorities and configurations present in the database, e.g., the High Priority Port Scanner Daemon 154, the Port Scanner Daemon 158, and Vulnerability Scanner Daemon 160. The number of each type of sub process to run as well as the behavior of each while it is running can be altered by the user and stored as a runtime configuration in the database. These settings also control how the task priority is arranged and therefore which sub processes the Assessment Daemon runs and at what times. The results from all of the assessment sub processes are stored back in to the Control Database 170, and these results may lead to the reprioritization of further subtasks.

Considering the Port Scanner Daemon 158, the purpose of the Port Scanner Daemon 158 is to find all open TCP and UDP ports on a host from the full set of 65,535 possible ports. The Port Scanner Daemon 158 references the list of hosts found by the Host Scanner Daemon 130 and scans them for open ports. The Port Scanner Daemon 158 is responsible for finding all open ports on a host, TCP or UDP, from port 1 through port 65,535. Such a TCP scan can typically be done rather quickly, but due to the nature of UDP, a very long expiration typically needs to be endured for each host. For this reason, most other scanners typically cannot check all 65,000+UDP ports in a reasonable amount of time. The Port Scanner Daemon 158 employs a “UDP-wrapped TCP connection” to scan for the two protocols simultaneously on each port. Specifically, the scanner will first bind to the UDP port that has the effect of sending a UDP packet. If the port is unavailable, an ICMP response will be sent back from the target host. However, if it is available and accepting packets, no response will be sent from the host and the scanner must wait for timeout and then assume the port is available. The question becomes how long to wait for the timeout. While waiting, the Port Scanner Daemon 158 will attempt a TCP connection to the same port. A full connection will be consummated or denied very quickly and the UDP should need no additional time to send a response if one is to be sent at all. So, once the TCP connection is completed, the UDP-bind status can be checked. If it is still available, no rejection response has been returned and the scanner can fairly accurately assume that the UDP port is open. However, if the bind had been closed during the TCP check, the UDP port is confirmed to be closed. This approach provides a check of both the UDP and TCP port in about the time it takes to do just the TCP. Other scanning tools perform a similar wrap of the TCP connection, but do not perform the TCP scan “for free” as does the PSD. These other tools will do a full TCP scan, separately from the UDP, and then use the same port or set of ports inside the UDP-bind, regardless of the UDP port being scanned. The present Port Scanner Daemon 158, thus represents a significant performance advantage over other scanners. The Port Scanner Daemon 158 is capable of performing a full TCP and UDP port scan against a single host in less than 2.5 minutes. The Port Scanner Daemon 158 must use the Host Port Scanner 130 results as stored in the Control Database 170 as targets for the port scans and must use a priority-based system to determine when to re-scan a host for open ports. Once a host is scanned, it is moved to the bottom of the priority list and it filters to the top over time. As new scan lists and ranges are added to the job queue, the new IP addresses are placed at the top of the priority ordering system. The port-scan priority tracking must be separate from the host-scan priority tracking facility. The Port Scanner Daemon 158 port-scanning priority-system works on a “time-last-checked” basis to keep attributes from having to be updated to increase priority levels.

Considering the Vulnerability Scanner Daemon 160, the purpose of the Vulnerability Scanner Daemon 160 is to run vulnerability test on hosts and ports found by the Host Scanner Daemon 130 and the Port Scanner Daemon 158. All vulnerability checks are performed by plug-ins installed in the Plug-ins Database 164. Each of these plug-ins performs a specific vulnerability test on hosts/ports that meet criteria stored within the plug-ins themselves. The Vulnerability Scanner Daemon 160 matches plug-ins to database information gathered by the Host Scanner Daemon 130 and the Port Scanner Daemons 158, and runs each plug-in against appropriate targets. Results are once again stored to the database for final review by the end user. Since the system performs its work on a continual basis, the Vulnerability Scanner Daemon 160 scans in repetitive iterations. The Vulnerability Scanner Daemon 160 grabs a set of hosts in priority order to check for known vulnerabilities. Priorities are set at the host level, so when a particular vulnerability triggers a priority change, the entire host is re-scanned for vulnerability issues. When a new vulnerability test (plug-in) is installed, each host's current dataset is evaluated to see if a potential impact exists. If so, that host's vulnerability scan priority is raised and the Vulnerability Scanner Daemon 160 re-scans it accordingly. The Vulnerability Scanner Daemon 160 uses the Host Scanner Daemon 130 and Port Scanner Daemon 158 results as stored in the Control Database 170 as targets for the vulnerability scans. The Vulnerability Scanner Daemon 160 also uses a priority-based system to determine when to re-scan a host for vulnerabilities. Once a host is scanned, it is moved to the bottom of the priority list and filters to the top over time. As new scan lists and ranges are added to the job queue, the new IP addresses are place at the top of the priority ordering system. The vulnerability-scan priority tracking is separate from the host-scan and port-scan priority tracking facilities. The Vulnerability Scanner Daemon 160 vulnerability-scanning priority system works on a “time-last-checked” basis to keep attributes from having to be updated- to increase priority levels. The Vulnerability Scanner Daemon 160 must assess the need to run a particular plug-in by referencing the plug-in's dependencies in comparison to data found by the other scanning daemons. In other words, the Vulnerability Scanner Daemon 160 must be smart enough to withhold the execution of a plug-in against a target:port if attributes do not match criteria set by the plug-in. The Vulnerability Scanner Daemon 160 must check for new vulnerabilities on a regular basis, and absorb them into the process as they become available.

Considering the Plug-In Delivery Facility 168, the purpose of the Plug-In Delivery Facility 168 is to install new plug-ins that are made available over time, and to re-prioritize the scan order with respect to newly installed plug-ins. New plug-ins are regularly made available by downloading to make quick upgrades to the scanners' effectiveness as more vulnerabilities are discovered. These new plug-ins are injected into the Plug-ins Database 164 by the Plug-In Delivery Facility 168, making them immediately available for scanner usage. The Plug-In Delivery Facility 168 also performs an analysis of current host information to formulate a list of targets that may be susceptible to each new vulnerability. The vulnerability scan priority for these hosts are set to maximum such that the Vulnerability Scanner Daemon 160 can scan them immediately. The Plug-In Delivery Facility 168 downloads new plug-ins on a regular cycle based on a configurable setting of 24 hours or less. The Plug-In Delivery Facility 168 performs an analysis against each host when new vulnerabilities are injected into the Plug-ins Database 164, and re-prioritizes each host with matching criteria to top priority to initiate a vulnerability re-scan. The Plug-In Delivery Facility 168 also makes the appropriate database updates to record the vulnerability, version, and other attributes that are required for proper operations and reporting upon installation of a new plug-in.

Considering the Plug-Ins Database 164, the purpose of the Plug-Ins Database 164 is to store scanner plug-ins, each of which tests for a specific vulnerability. The Plug-ins Database 164 can simply be a directory or jar file that contains all of the plug-ins to be used by the Vulnerability Scanner Daemon 160. The Vulnerability Scanner Daemon 160 reads plug-ins to determine if any of their respective driving criteria are present for any host:port. If so, the Vulnerability Scanner Daemon 160 runs the plug-in and stores the results in the Control Database 170. The Plug-ins Database employs a version tracking mechanism for the plug-in library to help administrators and the Plug-In Delivery Facility 168 determine if an update is required to meet the latest vulnerability baseline. The Plug-ins Database 164 makes both existing and new plug-ins readily available to the Vulnerability Scanner Daemon 160 at runtime. Each plug-in must also contain dependency information that helps the Vulnerability Scanner Daemon 160 determine if the plug-in needs to be run against a particular host:port.

Considering the Control Database 170, the purpose of the Control Database 170 is to store all host, port, and vulnerability data as it is collected by the scanner daemons in a manner that facilitates tracking, management and reporting from the Graphical User Interface 185. The Control Database 170 provides all information needed to administer the scanner system and to perform scans. The major sub process, including Discovery or Host Scanning, OS Detection, and Assessment, use the Control Database 170 to define the priority of task completion. Any changes they make are then reported back into the database where other daemons use the information to determine if any further actions are necessary. Local configuration information is stored here, and pushed to the local file system when it is changed. Scanner daemons reference this data store to determine what should be scanned and when, and place results back in it for other processes and the end-user to access. The Control Database 170 also facilitates data separation and enforces authorization for the viewing of scan data. Data collected by the local scanning daemons are predestined for association with local jobs, and each local job is tied to an account. When a user logs into his account on the system, there is a distinct set of jobs he has access to, and access is denied to all non-associated data. Each scanner system must be configurable to accept information from remote scanners. Only authorized personnel are authorized to configure this transfer, but the Control Database 170 should take whatever steps are necessary to prevent the transfer of data across clients. This consolidation feature allows the user to define jobs that have local and remotely driven scan results, or to run correlation reports against remote jobs covered by multiple scanner systems. Since a potentially large amount of data may be consolidated into a single Control Database 170, each scanner system uses a low-cost database that is capable of scaling to large proportions. A relational database is a requirement, and performance must not inhibit access to potentially tens of thousands of records in multiple tables. The Control Database 170 uses a normalized low-cost relational database to ensure peak performance as the data store grows in size. The Control Database 170 facilitates the segregation of data into accounts and jobs, and the enforcement of data restriction between accounts. The Control Database 170 uses foreign keys and one-to-many relationships to enforce data integrity and reduce overall size. Table 1 shows the relationships the Control Database must support.

TABLE 1

| One | To Many | Identified By |
|---|---|---|
| Account | Jobs | Job ID |
| Job | Hosts | Host ID |
| Host | Ports | Port Protocol |
| Port | Vulnerabilities | Vulnerability ID, Version |

The Control Database 170 supports a role-based user model that grants and denies permission to perform the following actions:

/ enable / disable / remove accounts

/ enable / disable / remove / manage users system-wide (managing system users includes determining to which accounts a user can have access)

/ enable / disable/ remove / manage users account-wide

/ remove/ activate / deactivate / configure jobs

:/ import job data

/ revoke snapshot scheduling and purging privileges

/ revoke privileges over scan data (viewing, editing)

The Control Database 170 supports on-demand and scheduled snapshots of a job's vulnerability data, and facilitate the tracking of host availability, service availability, and vulnerability existence over time. It logs data-altering actions that users apply to the scan data, facilitates the import of scan data from remote scanner systems, and exports specified scan data to other scanner systems.

Considering the Configurator 180, the purpose of the Configurator 180 is to provide the user with a means to change the network configuration of the scanner system for allowing it to participate on the hosting network. The Configurator 180 provides a simple means for the network configuration to be changed. To minimize the number of external services available from the scanner system and to minimize the number of user interfaces, the Configurator 180 uses the Graphical User Interface 185 and a Java Database Connectivity (JDBC) interface to the Control Database 170 via the network 190 and the User Interface Gateway 175 to make changes to the system configuration. A system-level daemon or stored procedure within the database can be used to read the information from the database, and change it on the system (with proper re-initialization sequences) to get the changes in place and operational. The Configurator 180 facilitates the configuration of an IP address on a network card. This web administration interface is configured on the hosting LAN for scanning and end-user access. Another interface, a serial interface, provides all of the key functions as the web administrator interface. The other is a virtual interface that is intended to provide a pseudo-out-of-band access to the scanner system. The virtual interface can be used to re-configure the primary interface. The Configurator 180 enables the user to specify the IP address, Subnet mask, and Default Gateway for both the primary and virtual interface. It does not allow the user to change the configuration information of the interface being used to re-configure the box. The Configurator 180 stores the network configuration information in the Control Database 170, as well as a procedure that gets triggered when interface configuration data changes. This stored procedure must create and install new network configuration files to the local file system and initiate a restart of the network facilities.

Considering the Graphical User Interface 185, the purpose of the Graphical User Interface 185 is to provide the end-user with an graphical representation of the scanner's findings, to give the end-user a means of massaging that data into insightful information, to provide a means to receive alerts triggered by scanned results, and to provide a security management interface that allows the end user to systematically address the security issues found by the scanner system. While the scanning engine knows only of scan ranges, hosts, ports, and vulnerabilities, scan targets are logically segregated into jobs for ease of use considerations. An end-user can specify a discrete list or range of hosts and a job name that represents them. The Host Scanner Daemon 130, in turn, checks each IP address in the list or range of each job to determine if it is present on the network. If it is, the port priority is raised to the highest level to trigger a port scan of the host. If it is not, its priority is dropped to the lowest setting to be rechecked at a later time. The same host can logically be a part of multiple jobs. For example, a user may have a job named “Servers” and another named “IT Assets”, both of which may contain the client's E-mail Server. When the second job is added, no additional entry needs to be made to the scanner, but the scanner's results for that host will be available to both jobs. Since a scanner system can be used for consolidation of scan data from several remote scanner systems, the database and Graphical User Interface 185 need to provide a means to define jobs from other scanners in such a way that does not trigger the local Host Scanner Daemon 130 to attempt to scan the hosts defined therein. This is accomplished by defining a separate JOB_TARGETS table that the Host Scanner Daemon 130 references for potential targets. Jobs that represent remote activities receive no entries in the targets table, unless locally scanned targets are to be joined with the remote results. A consolidator scanner system can be used for multiple accounts. Therefore, it is imperative that the Graphical User Interface 185 does not permit one user to define a job that encompasses another user's results. Furthermore, when results are sent from one scanner system to another, the job ID's must be pre-coordinated from both scanner systems. Although only a user who has administrative privileges over both accounts can do this, the system must be designed to eliminate this possibility. The Graphical User Interface 185 is designed to provide multiple master-detail views of the scan data. The user can be presented with a list of valid jobs on his account and scroll through the host list or list of alerts for each job. Given a list of hosts, the user can scroll through a set of open ports or vulnerabilities. Graphical reports are available from all levels with drill-down capability to the finest details of the targets, including descriptions of vulnerabilities and instructions on how to fix them. The Graphical User Interface 185 enables user management configuration with default capabilities as shown in Table 2.

TABLE 2

| | Executive | Technician | AccountAdmin | Administrator |
|---|---|---|---|---|
| Manage | | | | X |
| accounts | | | | |
| Manage | | | | X |
| system-wide | | | | |
| users | | | | |
| Manage | | | X | X |
| account- | | | | |
| wide users | | | | |
| Alter | | | | X |
| scanner | | | | |
| configuration | | | | |
| Job | | | X | |
| management | | | | |
| Export/ | | | X | |
| import job | | | | |
| data | | | | |
| Snapshot | X | X | X | |
| scheduling | | | | |
| Editing scan | | | X | |
| data | | | | |
| RMS | | | X | |
| management | | | | |
| RMS | | X | X | |
| workoff | | | | |
| Viewing | X | X | X | X |
| scan & RMS | | | | |
| data | | | | |

Account management includes the creation, enabling, disabling, and removal of accounts, as well as scan boundary definition. When an account is removed, all associated data is removed as well. The Graphical User Interface 185 allows the removal of all account information without forcing a removal of the account itself, and account data removal includes an option to remove only scan data or to remove both scan and administrative data. Administrative data includes users, scan range definitions, exclusions lists, criticality lists, or any other data that is not discovered by a scanning daemon. User management includes the creation, enabling, disabling, privilege editing, and password re-creation of user accounts. Scanner system configuration includes setting of the IP address, Subnet Mask, and Default Gateway of both the primary and virtual interfaces. Job management includes the creation, deletion, activation, and deactivation of jobs. On job creation, the user is permitted to include IP addresses that are part of another job on the same account, but the user is denied the ability to include IP addresses that are outside the permitted boundary of the account. On Job deletion, the scanner system deletes all data associated with all hosts on the job, except for hosts that are part of another job on the same account. On job data exportation, the user specifies the remote scanner system, remote job to send data to, and the local job the data is being exported from. On job data importation, the user specifies the remote scanner system and remote job data is being accepted from, and the local job the data is being imported into. When defining the local job for data importation, the user has an option to import into a new or existing job, whereby the existing job may be one that gathers information via the local scanner, or a consolidation from another scanner. The Graphical User Interface 185 permits the user to schedule snapshots of scan data for audit purposes, whereby the scheduling may be an immediate snapshot, a future one-time snapshot, or a recurring periodic snapshot. The number of stored snapshots is limited to 12 per job. When scheduling a periodic snapshot, the Graphical User Interface 185 gives the user an option to purge oldest snapshot data when limit is reached. The Graphical User Interface 185 permits a user to manually purge a selected job snapshot, and provides a means to specify criticality levels of each host. A criticality level is a subjective measure of how important the host is to the client's operations. A high criticality relates to a major impact to the client if it is compromised. The Graphical User Interface 185 provides a Risk Management System (RMS) that allows Account Administrators to assign vulnerabilities to individual users to fix. The Risk Management System provides a means for the user to check off a vulnerability as fixed. This update must also re-prioritize the associated host to be re-prioritized to the top of the scan list for immediate verification of the fix. The Graphical User Interface 185 provides the ability to mark each host, port, and vulnerability as “don't care” or “ignore”, and provide an ability to annotate the reasons for declaring it so. It also provides a graphical reporting interface with drilldown ability from executive-level summaries, to a technician's instructions on how to resolve the problem. The Graphical User Interface 185 is capable of displaying its information using a Master-Detail-Summary paradigm as described in Table 3. The “Summary” part of this equation is a graphical executive summary of the master record. The Continental Summary resides on the main screen of the interface. The Island Summary is a small (disable-able) pop-up window with a Graphical Executive Summary of the master record.

TABLE 3

| Master | Detail | ContinentalSummary | IslandSummary |
|---|---|---|---|
| Account | User | Score | Usage |
| | Management | | Summary |
| Account | Job | Score | Rating-at-a |
| | Management | | glance |
| Account | Job list | Score | Rating-at-a- |
| | | | glance |
| Account | Alerts | Score | Alerts Report |
| Job | Job | Score | <none> |
| | specification | | |
| Job | Hosts | Score | Rating-at-a- |
| | | | glance |
| Job | Uptime History | Score | Hosts-over-time |
| Job | Reports | Score | Rating-at-a- |
| | | | glance |
| Job | Export | Score | <none> |
| Job | Import | Score | Rating-at-a- |
| | | | glance |
| Host | Host | Score | <none> |
| | specification | | |
| Host | Ports | Score | Ports-at-a- |
| | | | glance |
| Host | Vulnerabilities | Score | Risk-at-a- |
| | | | glance |
| Host | RMS | Score | Risk-at-a- |
| | | | glance |
| Host | Uptime History | Score | Uptime-over- |
| | | | time |
| Host | Service History | Score | Ports-over-time |
| Host | Vulnerability | Score | Vulns-over-time |
| | History | | |
| Host | Reports | Score | Risk-at-a- |
| | | | glance |

Considering the Sync Daemon 120, the purpose of the SYNC Daemon 120 is to schedule incremental and full synchronizations, respond to ad-hoc synchronization requests, and to import synchronized data. At system startup, if scheduled synchronization is enabled, the Supervisor Daemon 110 starts the Sync Daemon 120. When the Sync Daemon 120 first starts, it reads its configuration information out of the Control Database 170. This configuration information includes the parent node to which it sends database synchronizations, how often to perform an incremental synchronization, and at what time of day a full synchronization is to occur. At each incremental checkpoint, the Sync Daemon 120 packages the changes since the last incremental update and securely transmits them to its designated parent. At the scheduled full synchronization time, the Sync Daemon: (1) requests via the Supervisor that all client and scanner process be suspended; (2) performs a full database dump; and (3) uses the network to send the full dump to the designated parent. At any time the Sync Daemon 120 may also receive a request for full or incremental database sync from its designated parent. If this request originates from its parent, it then performs the requested action exactly as if it had been the regularly scheduled action. The Sync Daemon 120 is also responsible for importing validated database synchronized data. For any given node, if synchronized data arrives from a designated child node, that data is immediately imported into the local database. By using the same mechanism on every scanner system, it is possible to build hierarchies of data replication, rather than just a single tier.

Considering the Web Administrator Daemon 114, the Web Administration Daemon 114 provides an interface for controlling the majority of the system-wide settings, including those that are not made via the database. These include changing the IP address of the scanner system, performing database backups and restorations, requesting and installing system licenses, changing the update source, and downloading the client application installer to a workstation.

Considering the Serial Console Daemon 118, the Serial Console Daemon 118 is a basic set of system configuration tools that includes the ability to request that the Supervisor Daemon 110 shutdown the Web Administration Daemon 114 and the User Interface Gateway 175 so that the scanner system may be safely deployed outside of a firewall for external use.

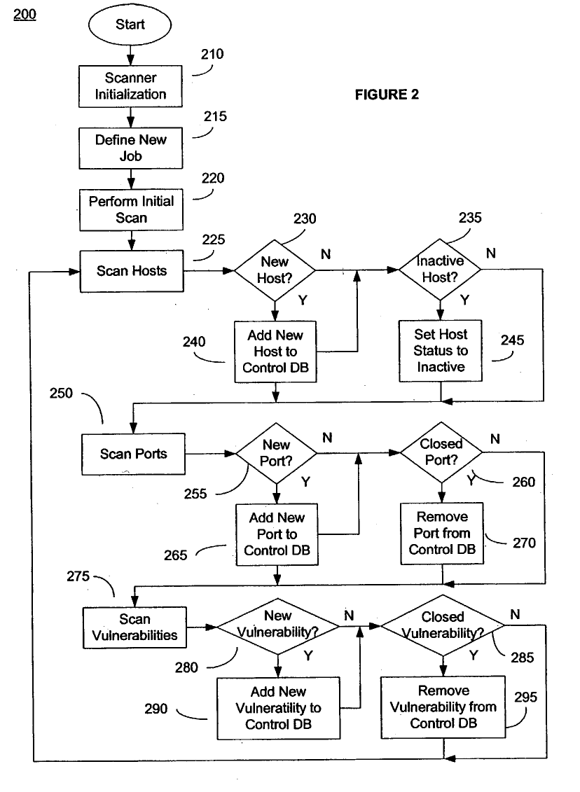

Turning now to FIG. 2, FIG. 2 shows a flow diagram 200 of the operation of an embodiment of the present invention. Once the network scanner system is booted up, it is initialized 210 by configuring the scanner for the host network and defining at least one new user account. A user on a client workstation that is running the Configurator 180 performs the initialization process. The user configures his workstation to communicate on the scanners User Interface Gateway 175. This interface will likely be out of range of the hosting network, so there must be no routers between the workstation and the scanner. The user opens a browser and navigates to the IP address of the scanner's User Interface Gateway 175. The Application Server returns the default web page to the user's browser. The default web page opens a separate window in which the Configurator applet 180 is launched. The user accesses the Configurator portion of user application, changes network configuration information for the scanner's primary interface, and commits the changes to the scanner Control Database 170. The Control Database 170 triggers an external process to read the updates, apply them to the operating system, and restart the network services with the new settings. The user can re-configure the workstation back to its previous settings so it can participate on the network once again. The scanner should now be listening at the designated IP address. To configure a new account, the user navigates to the Accounts Master-Detail interface in the Configurator applet 180. The user inserts a new row in the Master pane, fills in the displayed data fields, and commits the record. The user must now define a new job 215 using the Graphical User Interface 185.

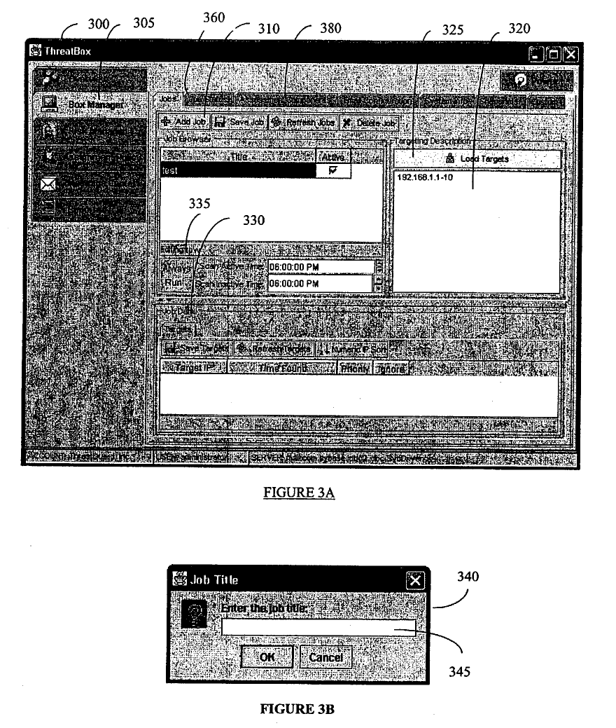

Turning now to FIG. 3, FIG. 3 shows screen shots used for adding jobs to a scanner using the Graphical User Interface 185. FIG. 3A shows the Box Manager 300 with the Box Manager tab selected, which is the primary window for setting up jobs using the Graphical User Interface 185. Using this interface, jobs may be defined and customized on a per job basis. To add a new job, the user selects ADD JOB 310 to display a pop up window 340 shown in FIG. 3B. The window shown in FIG. 3B provides a text box for a user to enter a job title 345. Users may also enter a target range of job IP addresses in a LOAD TARGETS text box 320, shown in FIG. 3A, and then click the LOAD TARGETS button 325 to save the targets for the job. The targets are then displayed in the JOB DETAIL window 330 in the lower half of the Box Manager window 300. Using the. JOB DETAIL window 330, any host may be given a higher priority or ignored. Scan times may also be customized for a selected job in the EDITING ROW window 335 in the middle of the Box Manager window 300. The JOB STATUS tab 360 in the Box Manager window 300 of FIG. 3A enables the Job Status display 370 of the current status of each job set to run on the selected scanner, as shown in FIG. 3C. Individual job status may be viewed by clicking on each Job Title 375. Inactive jobs are shown with a “Job Inactive” message appearing in red text. The ASSESSMENT COMPONENTS tab 380 of the Box Manager 300 of FIG. 3A enables the Scanner Components display 390 for customizing scanner components, as shown in FIG. 3D. Each functional component of the scanner may be activated or deactivated by the user. This action affects all jobs defined for this scanner.

Returning to FIG. 2, after a job is defined 215 by selecting a range of hosts, as explained above, an initial scan is performed 220. When performing an initial scan 220 resulting from a new job definition 215, an prioritization of all hosts in the job's scan range is initiated by setting their timestamps TimeSinceLastHostScan* value to 0. When the Host Scanner Daemon 130 references the Control Database 170, it pulls target IP addresses in priority order. The job's hosts will thus be picked up on the next iteration of scans. Once a new host is initially scanned, it is moved to the bottom of the priority list. The scanner performs an iterative evaluation by scanning all hosts 225, scanning all ports of each host 250 and scanning all vulnerabilities of each port 275. When the Host Scanner Daemon 130 completes a scan on a range of ports for an IP address, it sets the TimeSinceLastHostScan value for that host to the current time, now( ). As subsequent scans are executed against other hosts, the Host Scanner Daemon 130 updates them to the later, then current time. The Host Scanner Daemon 130 eventually recognizes the earlier scanned host as being in a group with the lowest TimeSinceLastHostScan values. The Host Scanner Daemon 130 thus initiates another iteration. The Daemon Supervisor 110 controls the overall evaluation iteration comprising host scanning, port scanning, and vulnerabilities scanning.

Considering the scanning of hosts 225, the Host Scanner Daemon 130 references the list of potential targets from the Control Database 170. The Host Scanner Daemon 130 sends a TCP SYN packet to every host on the list while listening for responses in a separate thread. If an IP address does not respond, its TimeSinceLastHostScan value gets updated to now( ) so a future iteration can re-check it. When an IP address does respond, indicating a new host 230, the Host Scanner Daemon 130 gathers available information about the host and stores it 240 in the Control Database 170. These may data include hostname, NetBIOS name, MAC address, and IP address. When a host does not respond after having been identified and added to the Control Database 170, the Host Scanner Daemon 130 performs two (2) additional connection attempts. If all three connection attempts fail, indicating an inactive hast 235, the host is updated to “Inactive” 245 in the Control Database 170. The TimeSinceLastHostScan and TimeSinceLastPortScan values are each set to now( ), preventing the other scanner daemons from scanning an inactive target. The service for TimeSinceLastVulnScan is reset on that host, which pops that service back up to the top of the priority stack. The next rescan of that service will then include the new plug-in and all other tests that the new plug in is dependent upon.

Considering the scanning of ports 250, the Port Scanner Daemon 158 selects a group of hosts to scan as ones with the lowest TimeSinceLastPortScan value. For each host, the Port Scanner Daemon 158 performs a UDP bind against each port on the target. To give adequate time for the ICMP port unreachable response (and because it needs to be done anyway), the Port Scanner Daemon 158 makes a TCP connection to the same port. Once the TCP connection attempt is complete, the Port Scanner Daemon 158 checks the state of the UDP bind. If the bind has failed, an ICMP port unreachable response has been received and the port is confirmed to be close. If the bind has not yet failed, it is safe to assume the UDP port is open. If the TCP connection was successful or the UDP bind remains valid, indicating a new port 255, the Port Scanner Daemon 158 inserts a new record in the ports table 265 for the appropriate host:port:protocol combination. If either the connection or bind attempts fail, and the associated host:port:protocol combination were previously recorded as open, then the Port Scanner Daemon 158 makes two (2) additional connection or bind attempts spaced approximately five (5) seconds apart. If all three (3) attempts fail, indicating a closed port, the Port Scanner Daemon 158 removes the port:protocol from the Control Database 170.

Considering the scanning of vulnerabilities 275, after the full scan a heuristic is applied to the list of open UDP ports to determine the level of trust in its accuracy. Once the Port Scanner Daemon 158 completes the port scan for each host, it updates that host's TimeSinceLastPortScan value to now( ), re-prioritizing it for future iterations. The Vulnerability Scanner Daemon 160 selects a group of hosts to scan as ones with the lowest TimeSinceLastVulnScan values or hosts marked as high priority hosts. For each host, the Vulnerability Scanner Daemon 160 checks the dependencies for each plug-in in the Plug-ins Database. The Vulnerability Scanner Daemon 160 runs a plug-in against each host:port:protocol combination that meets the dependency criteria for that plug-in. If the plug-in reports success in the vulnerability check, indicating a new vulnerability 280, the Vulnerability Scanner Daemon 160 inserts a new record in the host vulnerabilities table for the associated host:port:protocol 290, in the Control Database 170. If a vulnerability check returns negative results where a vulnerability existed before, the Vulnerability Scanner Daemon 160 performs two (2) additional checks spaced approximately five (5) seconds apart. If all three checks report negative results, indicating a closed vulnerability 285, the Vulnerability Scanner Daemon 160 removes the vulnerability from the host:port:protocol 295 in the Control Database 170. Once the Vulnerability Scanner Daemon 160 completes the vulnerability scan for each host, it updates that host's TimeSinceLastVulnScan value to now( ), re-prioritizing it for future iterations.

The Plug-in Delivery Facility 168 periodically checks a central application server for new versions of software modules. The Plug-in Delivery Facility 168 uses standard Internet protocols to retrieve modules that have later versions than those installed on the scanner. This includes updates to the library of plug-ins in the Plug-Ins Database 164. On receipt of a new plug-in, the Plug-in Delivery Facility 168 reads the Plug-In Database information from the plug-in itself and inserts it into the database. The Plug-in Delivery Facility 168 then reads the new plug-in dependencies and generates a list of hosts that match the criteria. The Plug-in Delivery Facility 168 sets the TimeLastVulnScan value to 0 for each host on the list, causing those hosts to be re-assessed on the next iteration. When the Vulnerability Scanner Daemon 160 next runs an assessment on each host, the completion time of each previously-run plug-in is compared to the current time, and only those not run recently will be re-run, which will include the new vulnerability and all of its dependencies, if any.

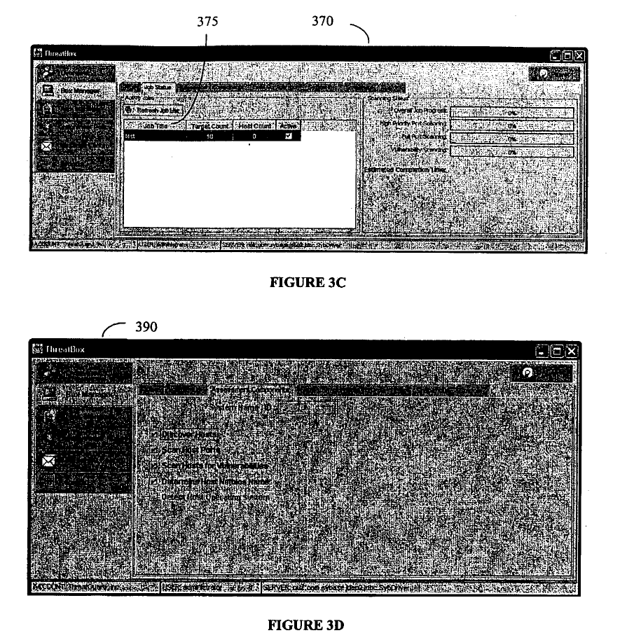

Turning now to FIG. 4, FIG. 4 shows a screen shot 400 used for reviewing scan results. FIG. 4 shows the Box Manager 400 with the Risk Manager tab 405 selected, which is the primary window for showing the results of scan jobs using the Graphical User Interface 185. A job is selected by entering data into the Job Title window 410. Vulnerabilities can be viewed per host by clicking a Host-Centric tab 420 or by vulnerability by clicking a Vulnerability-Centric tab 430. Detailed information can be found in the Host Vulnerabilities window 440. Open ports may be viewed by clicking the Open Ports tab 450, and problems are described in the Problem Description window 470. A Graphic 460 provides a means of quickly and easily identifying the risk levels in a network.

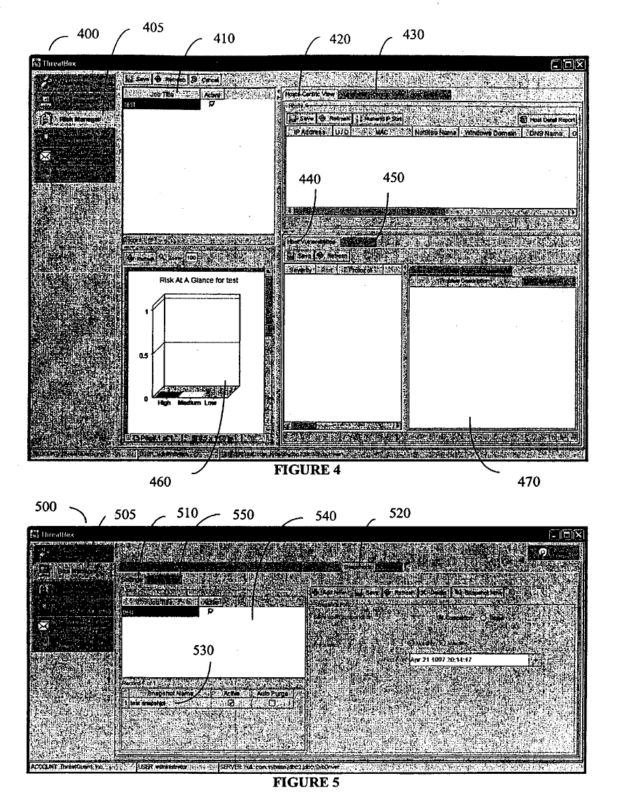

Turning now to FIG. 5, FIG. 5 shows a screenshot 500 used by a user to save the state of a scan as a snapshot. FIG. 5 shows the Box Manager 500 with the Box Manager tab 505 selected, which is the primary window for managing the scanner using the Graphical User Interface 185. Clicking the Snapshot tab 520 and entering a job title in the Job Title window 540 of a setting text box 510 selects a snapshot. The Box Manager Snapshots tab 520 allows the user to save the state of a scan at any point in time. Snapshots can be scheduled for each individual job or the user can take them instantaneously. Each job can have multiple snapshots scheduled. Each instance of a scheduled snapshot is listed on the Maintenance tab 550 of the Snapshots view 500.

Although the present invention has been described in detail with reference to certain preferred embodiments, it should be apparent that modifications and adaptations to those embodiments might occur to persons skilled in the art without departing from the spirit and scope of the present invention.

1. A method for scanning network nodes for detection and reporting of security vulnerabilities, comprising the steps of:
scanning all network host nodes within designated address ranges for determining all active hosts;
scanning all ports in each active host for determining all open ports;
scanning each port of each active host for detecting security vulnerabilities;
notifying a user of all open ports and detected security vulnerabilities; and
repeating the scanning and notifying steps above in an iterative manner.

2. The method of claim 1, further comprising the steps of:
initiating a new scan job by entering a new set of address ranges by a user into a control database; and
executing an initial high priority port scan based on detecting an active host having an address within the new set of address ranges.

3. The method of claim 1, wherein the step of scanning all network nodes within designated address ranges further comprises the steps of:
accessing a control database for determining designated address ranges;
storing the status of each active host and inactive host in the control database; and
removing a host designated as inactive from the control database if the host remains inactive for a predetermined number of scan cycles.

4. The method of claim 3, wherein the step of removing a host designated as active comprises removing a host designated as inactive from the control database if the host remains inactive for a predetermined time period.

5. The method of claim 3, further comprising the steps of:
adding a new host designated as active to the control database when first detected; and
executing an initial high priority port scan based on detecting a new active host.

6. The method of claim 1, wherein the step of scanning all ports comprises the steps of:
simultaneously scanning each port using a User Datagram Protocol bind attempt and a Transmission Control Protocol connection attempt;
determining the state of the User Datagram Protocol bind upon completion of the Transmission Control Protocol connection attempt;
confirming a closed state of a port upon failure of either the User Datagram Protocol bind attempt or the Transmission Control Protocol connection attempt;
confirming an open state of a port if both the User Datagram Protocol bind remains valid and the Transmission Control Protocol connection attempt was successful; and
determining a rate limiting of the target host and the round trip time of the network connection to that host.

7. The method of claim 6, further comprising the step of tracking port status changes over time for reporting the changes to a user.

8. The method of claim 1, wherein the step of scanning all ports comprises the steps of:
accessing a control database for determining a designated highest priority active host;
scanning all ports on the designated active host for determining open ports;
storing the status of each open port and each closed port in the control database; and
removing a port designated as closed from the control database if the port remains closed for a predetermined number of scan cycles.

9. The method of claim 8, wherein the step of removing a port designated as closed comprises removing a port designated as closed from the control database if the port remains closed for a predetermined time period.

10. The method of claim 8, further comprising the step of adding a new port designated as open to the control database when first detected.

11. The method of claim 1, wherein the step of scanning each port of each node comprises the steps of:
accessing a control database for determining a designated highest priority group of active hosts;
for each host in the group of designated active hosts, checking the dependency criteria for each vulnerability plug-in module in a plug-ins database;
running a vulnerability plug-in module against each host and port combination that meets the dependency criteria of each plug-in module;
storing the status of each vulnerability found in the control database;
removing a vulnerability designated as closed from the control database if the vulnerability remains closed for a predetermined number of scan cycles; and
reducing the number of vulnerability tests using the current knowledge of the target host and service.

12. The method of claim 11, wherein the step of removing a vulnerability designated as closed comprises removing a vulnerability designated as closed from the control database if the vulnerability remains closed for a predetermined time period.

13. The method of claim 11, further comprising the step of adding a new vulnerability designated as open to the control database when first detected.

14. The method of claim 11, further comprising the step of tracking vulnerability status changes over time for reporting the changes to a user.

15. The method of claim 11, further comprising the steps of:
periodically checking a central application server for new versions of plug-in modules;
retrieving plug-in modules from the central application server that have later versions than the corresponding plug-in modules stored in the plug-ins database;
storing the latest updated version plug-in modules in the plug-ins database;
reading the dependency criteria of each updated plug-in module and generating a priority list of hosts that match the criteria;
setting a highest priority for vulnerability scanning to the hosts on the priority list; and
performing a vulnerability assessment on each host on the priority list by scanning the hosts.

16. The method of claim 1, wherein the step of notifying a user comprises transmitting all host, port, and vulnerability status to a graphical user interface on a client workstation via a user interface gateway and a communications network.

17. The method of claim 1, wherein the step of notifying a user comprises a snapshot having a periodicity determined by the user.

18. A computer-readable medium containing instructions for controlling a computer system to implement the method of claim 1.

19. A system for scanning network nodes for detection and reporting of security vulnerabilities, comprising:
means for scanning all network host nodes within designated address ranges for determining all active hosts;
means for scanning all ports in each active host for determining all open ports;
means for scanning each port of each active host for detecting security vulnerabilities; and
means for notifying a user of all open ports and detected security vulnerabilities.

20. The system of claim 19, further comprising:
a graphical user interface connected to a control database via a user interface gateway and a communications network for initiating a new scan job by entering a new set of address ranges by a user into a control database; and
a daemon supervisor and a high priority port scanner daemon for executing an initial high priority port scan based on detecting an active host having an address within the new set of address ranges.

21. The system of claim 19, wherein the means for scanning all network nodes within designated address ranges comprises a host scanner daemon for accessing a control database, for storing the status of each active host and inactive host in the control database, for removing a host designated as inactive from the control database, and adding a new host designated as active to the control database when first detected.

22. The system of claim 19, further comprising a high priority port scanner daemon for executing an initial high priority port scan based on detecting a new active host.

23. The system of claim 19, wherein the means for scanning all ports comprises a port scanner daemon for determining the open or closed status of each port of each host node.

24. The system of claim 19, wherein the means for scanning all ports comprises a port scanner daemon for accessing a control database, scanning all ports on a designated active host, storing the status of each open port and each closed port in the control database, and removing a port designated as closed from the control database.

25. The system of claim 19, wherein the means for scanning each port of each active host comprises a vulnerability scanner daemon for accessing a control database, checking the dependency criteria for each vulnerability plug-in module in a plug-ins database, running a vulnerability plug-in module against each host and port combination that meets the dependency criteria of each plug-in module, storing the status of each vulnerability found in the control database, and removing a vulnerability designated as closed from the control database.

26. The system of claim 19, further comprising a plug-in delivery facility for periodically updating plug-in modules in a plug-ins database used for detecting vulnerabilities.

27. The system of claim 19, wherein the means for notifying a user comprises a graphical user interface on a client workstation connected to a control database via a communications network and a user interface gateway for receiving all host, port, and vulnerability status.

28. The system of claim 19, further comprising means for collecting snapshots of current system status as determined by the user.

29. A system for scanning network nodes for detection and reporting of security vulnerabilities, comprising:
a user interface on a client workstation connected to a network scanner via a communications network and a user interface gateway for configuring and initializing the scanner, defining scan jobs, and receiving results of security assessments of designated host nodes within a network; and
the network scanner system including a daemon supervisor, a host scanner daemon, an operating system daemon, a port scanner daemon, a vulnerability scanner daemon, a control database, and a plug-in database.
